(19) United States
(12) Patent Application Publication
(10) Pub. No.: US 2010/0129501 A1
(43) Pub. Date: May 27, 2010

(54) METHODS AND COMPOSITIONS FOR PRESERVING EGG PRODUCTS

(75) Inventors: Tracy Blommer, St. Cloud, MN (US); Todd McAloon, Eden Prairle, MN (US); Michael Saunders, St. Louis Park, MN (US)

Correspondence Address: CARGILL, INCORPORATED, P.O. Box 5624, MINNEAPOLIS, MN, 55440-5624, US

(73) Assignee: CARGILL, INCORPORATED, WAYSATA, MN (US)

(21) Appl. No.: 12/602,531

(22) PCT Filed: Jul. 17, 2008
(86) PCT No.: PCT/US08/08739

§ 371 Date: Dec. 1, 2009

Related U.S. Application Data
(60) Provisional application No. 60/950,988, filed on Jul. 20, 2007.

(51) Int. Cl. A23B 5/14; B65D 85/72; A23L 1/32

(52) U.S. Cl. 426/106; 426/298

(57) ABSTRACT

Methods and compositions for inhibiting Listeria growth in pre-cooked egg products during refrigeration are described. According to one embodiment, a liquid egg material is combined with an antibacterial composition including Nisin and one or more organic acids or salts thereof prior to cooking.

### CROSS-REFERENCE TO RELATED APPLICATION

This application claims the benefit under 35 U.S.C. §119(e) of U.S. provisional application 60/950,988 entitled “Methods and Compositions For Preserving Egg Products,” filed on Jul. 20, 2007, which is hereby incorporated by reference in its entirety.

### TECHNICAL FIELD

The present invention relates to egg products and methods of making egg products. More particularly, the present invention relates to methods and compositions for preserving pre-cooked egg products prior to consumption.

### BACKGROUND

Ready-to-eat breakfast products such as scrambled eggs, breakfast sandwiches, breakfast burritos and the like typically include a pre-cooked egg material such as a pre-cooked egg filling, patty or loaf. As used herein, “pre-cooked” refers to an egg material that is cooked and then stored for extended periods under conditions (e.g., packaging conditions, temperature conditions, etc.) suitable for commercial distribution and sale prior to consumption. These pre-cooked egg materials are typically formed from a mixture of liquid whole egg or egg whites and optional edible non-egg materials such as meats, cheeses, or vegetables and/or other optional ingredients. The liquid egg material is then cooked, for example, by conventional scrambling techniques or by depositing the liquid egg material in an egg pan and cooking in an oven to form a patty or other insert. The resulting pre-cooked egg material is optionally combined with other food materials (e.g., bagels, croissants, tortillas, sausage patties, etc.) and packaged for distribution and sale. Such pre-cooked products generally remain frozen up until the time of consumption to reduce the chance of spoilage, decomposition or food safety risks caused by, for example, bacterial growth.

Although it would be beneficial in many cases to provide refrigerated pre-cooked products that do not need to be frozen up until the time of consumption, concerns relating to bacterial growth and food safety have posed a barrier to such a refrigerated product. One such bacteria that occurs in egg products is listeria monocytogenes (“Listeria”). The U.S. Department of Agriculture (USDA) encourages refrigerated food products to have no more than 2 log average Listeria growth over the shelf life of the refrigerated product. Without treatment, however, pre-cooked egg products may exceed 2 log Listeria growth in less time than desirable to provide a suitable refrigerated shelf life.

### SUMMARY

One embodiment of the present invention is a method for preparing a food product containing a pre-cooked egg material. A liquid whole egg material is prepared and combined with an anti-bacterial composition. The liquid whole egg material is then cooked to form the pre-cooked egg material and then packaged for distribution. The pre-cooked egg material is then stored under refrigeration conditions for a period of time prior to consumption while maintaining suitable levels of Listeria growth.

Suitable antibacterial compositions for embodiments of the present invention may include Nisin and/or at least one organic acid or organic acid salt. In one embodiment, the antibacterial composition includes Nisin and at least two organic acid salts such as a sorbate salt and a propionate salt or benzoate salt. In certain embodiments, the pre-cooked egg material is capable of being refrigerated for at least about 10 weeks while maintaining suitable levels of Listeria growth.

Another embodiment of the present invention is a packaged pre-cooked whole egg product including an antibacterial composition in an effective amount to inhibit Listeria growth under refrigerated conditions.

The cooked egg product may include less than about 25 ppm Nisin, and may include one or more organic acids or organic acid salt salts. Yet another embodiment of the present invention is a packaged cooked egg product that includes an antibacterial composition formed from Nisin, a sorbate such as potassium sorbate and a propionate such as sodium propionate and/or a benzoate such as sodium benzoate.

### BRIEF DESCRIPTION OF THE DRAWINGS

FIG. 1 is a flow-chart illustrating a method of preparing a pre-cooked egg material according to an embodiment of the present invention. FIG. 2 is a graph showing average Listeria growth over time for a set of samples prepared according to Example 1.

FIG. 3 is a graph showing average Listeria growth over time for another set of samples prepared according to Example 2.

FIG. 4 is a graph showing average Listeria growth over time for a set of samples prepared according to Example 3.

FIG. 5 is a graph showing average Listeria growth over time for another set of samples prepared according to Example 3.

FIG. 6 is a graph showing average Listeria growth over time for a set of samples prepared according to Example 4.

FIG. 7 is a graph showing average Listeria growth over time for a set of samples prepared according to Example 5.

FIG. 8 is a graph showing average Listeria growth over time for a set of samples prepared according to Example 6.

FIG. 9 is a graph showing average Listeria growth over time for a set of samples prepared according to Example 7.

### DETAILED DESCRIPTION

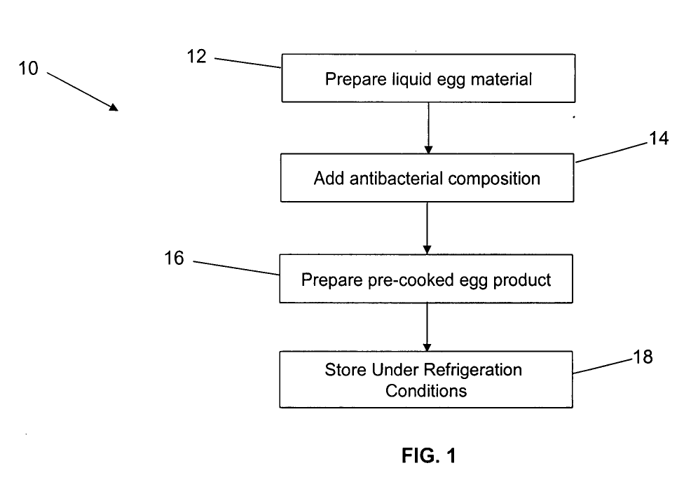

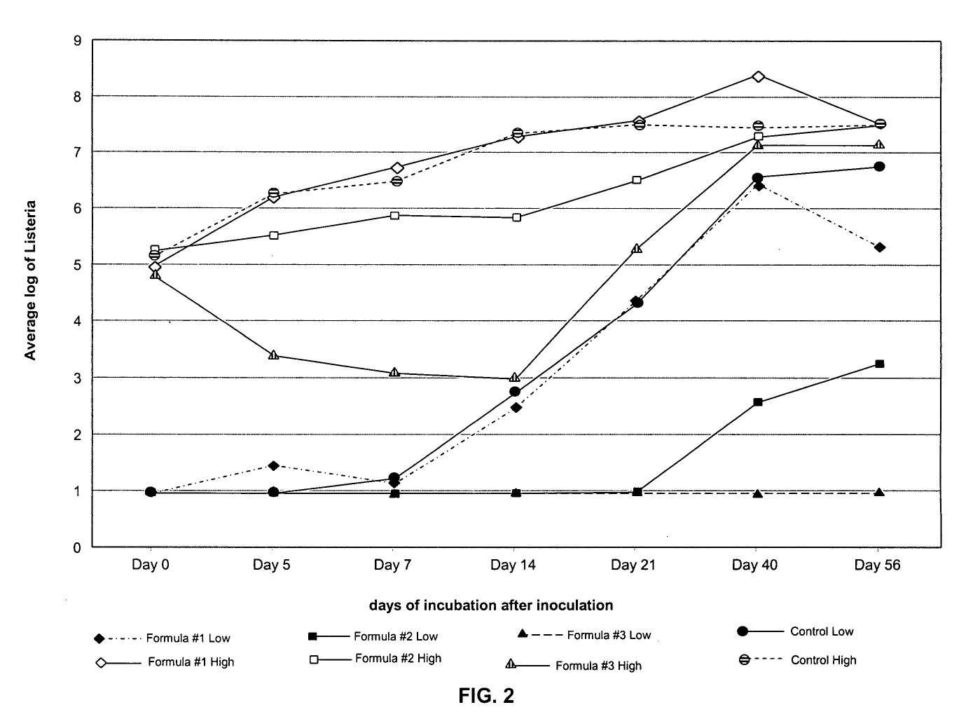

Embodiments of the present invention include methods and compositions for preparing pre-cooked egg products that inhibit the growth of bacteria such as Listeria, particularly during extended refrigerated storage. FIG. 1 is a flow-chart illustrating a method 10 of preparing such pre-cooked egg products according to one embodiment.

The method 10 includes the steps of preparing a liquid egg material 12, combining the liquid egg material with an antibacterial composition for inhibiting Listeria growth 14, preparing a pre-cooked egg product from the liquid egg material 16 and storing the pre-cooked egg product under refrigeration conditions suitable for inhibiting Listeria growth 18. Each of these steps are discussed in detail below.

### Prepare the Liquid Egg Material (12)

The liquid egg material may be prepared in a conventional manner, such as by shelling and mixing whole eggs to provide a generally homogenous liquid egg mixture. As used herein, the term “liquid egg material” refers to a liquid whole egg material unless otherwise noted. Various ingredients can be added to the liquid egg mixture, including water, dairy derivatives, oils, starches, thickeners, humectants, preservatives and/or flavorants. Additional food material such as cheese, meat and vegetables can also be added.

The liquid egg material may be pasteurized according to conventional methods. Pasteurization is generally accomplished by heating the liquid egg material at a sufficient temperature and for a sufficient period of time to kill certain types of bacteria that may be present in the liquid eggs.

Pasteurization is optional, but can be carried out before, after or during the addition of the antibacterial compositions described below.

### Add the Antibacterial Composition (14)

The antibacterial composition may be added to the liquid egg material at any time before, after or during preparation and/or pasteurization. For embodiments of the antibacterial composition that include several discrete components, the components may be combined prior to being added to the liquid egg material or may be added separately. In an alternate embodiment, the antibacterial composition may be combined with egg material after cooking, for example, by spraying or coating the cooked egg material with the antibacterial composition.

A variety of antibacterial compositions can be used according to embodiments of the present invention. According to one embodiment, suitable antibacterial compositions are capable of inhibiting bacterial growth in pre-cooked egg products that are refrigerated for an extended period of time, for example, at least about 2 weeks, more particularly, at least about 5 weeks, even more particularly, at least about 10 weeks. In certain embodiments, the antibacterial composition is capable of inhibiting average Listeria growth to less than 2 Log over the refrigerated shelf life of the pre-cooked egg product.

Suitable antibacterial compositions may include a variety of components in varying concentrations to inhibit Listeria growth under refrigeration conditions. Suitable components of such antibacterial compositions include, without limitation, Nisin, organic acids or organic acid salts, lysozymes and various combinations of these materials. Antibacterial compositions including Nisin may be particularly effective in inhibiting Listeria growth.

Nisin is an inhibitory polycyclic peptide with 34 amino acid residues. It contains the amino acids lanthionine, methyllanthionine, dehydroalanine and dehydro-amino-butyric acid. Nisin is produced by fermentation using the bacterium Lactococcus lactis. Due to its highly selective spectrum of activity it is employed as a selective agent in microbiological media for the isolation of gram-negative bacteria, yeast and molds. Nisin formulations are sold in varying active concentrations under several brand names, and generally include an inorganic salt carrier such as NaCl. Examples of such formulations include Nisaplin® and Novasin™, both available from Danisco A/S (Copenhagen) and Delvonis, available from DSM Food Specialties USA, Inc.

In one embodiment of the present invention, the antibacterial composition includes Nisin at a concentration of at least about 25 ppm of the liquid egg material. The examples set forth herein indicate that including at least about 25 ppm Nisin in the liquid egg material is effective in inhibiting Listeria growth in a refrigerated pre-cooked egg product.

However, because Nisin is a comparatively expensive material, the antibacterial composition of embodiments of the present invention include Nisin in combination with additional antibacterial components such as organic acids or salts thereof. In such embodiments, Nisin may be included in reduced concentrations, for example, less than about 25 ppm, more particularly, between about 5 and about 20 ppm, even more particularly, between about 10 ppm and about 20 ppm of the liquid egg material.

Suitable organic acids and organic acid salts for use in embodiments of the present invention include lactic acid or salts thereof (e.g., potassium lactate), acetic acid, acetate salts or diacetate salts thereof (e.g., potassium diacetate), propionic acid or salts thereof (e.g., sodium propionate), sorbic acid or salts thereof (potassium sorbate), benzoic acids or salts thereof (e.g., sodium benzoate) and/or combinations or derivatives of the foregoing components.

In one embodiment, the antibacterial composition includes Nisin and at least one organic acid or organic acid salt such as a sorbate salt (e.g., potassium sorbate). For example, the antibacterial composition may include less than about 25 ppm Nisin and at least about 0.1 wt % sorbate salt, more particularly, at least about 0.3 wt % sorbate salt. Even more particularly, the antibacterial composition may include between about 0.3 wt % and about 0.6 wt % sorbate salt.

In another embodiment, the antibacterial composition includes Nisin and at least two organic acids or organic acid salts such as a sorbate salt and propionate salt (e.g., sodium propionate). For example, the antibacterial composition according to this embodiment may include less than about 25 ppm Nisin, and at least about 0.1 wt %, more particularly, at least about 0.3 wt % of the sorbate salt and propionate salt. In another example, the antibacterial composition may include between about 0.3 wt % and about 0.6 wt % sorbate salt and between about 0.3 wt % and about 0.6 wt % propionate salt. In yet a further embodiment, a benzoate salt such as sodium benzoate is utilized instead of, or in addition to, the propionate salt at similar concentrations.

In yet another embodiment, the antibacterial composition includes Nisin and a lactate salt such as potassium lactate and/or a diacetate salt such as sodium diacetate. For example, the antibacterial composition according to this embodiment includes less than about 25 ppm Nisin, and up to about 3 wt % of Purasal HiPure PIus™ (78% potassium lactate) or Purasal Opti.Form PD PIus™ (72.8% potassium lactate, 5.2% sodium diacetate). In yet a further embodiment, the present invention includes Nisin and a lysozyme such as NovaGard brand Lysozyme and/or Novagard CB-1 brand lysozyme.

### Prepare Pre-Cooked am Product (16)

Once the liquid egg material is prepared and the bacterial composition added, the liquid egg material is cooked according to conventional practices to form a pre-cooked egg material. In one embodiment, for example, the liquid egg material may be deposited in a plurality of recesses formed in an egg pan. The deposited liquid egg material is then cooked by baking or steaming. For example, the egg pan may be advanced into an impingement oven that applies hot air to the liquid egg material at an operating temperature of between about 160° C. and 175° C. for between about 5 to 10 minutes until the center of the egg material is cooked. In another embodiment, the liquid egg material may be scrambled according to conventional practices.

The pre-cooked egg material may be combined with additional food materials and then packaged for distribution and sale as a pre-cooked egg product. For example, the pre-cooked egg product may be used in ready-to-eat breakfast sandwiches, burritos, wraps, and other ready-to-eat breakfast products. Of course, the pre-cooked egg product can be packaged and sold without additional food materials as well. Similarly, the pre-cooked egg product can be packaged, frozen, refrigerated and/or transported to a different location prior to being combined with additional foods or subjected to additional packaging.

In one embodiment, the pre-cooked egg product is packaged in modified atmosphere packaging (MAP). An example of suitable MAP packaging is an oxygen impermeable membrane or enclosure that contains a low oxygen atmosphere. MAP packaging may also assist in extending the refrigerated shelf life of the pre-cooked egg product

### Store Pre-Cooked Egg Product Under Refrigeration Conditions (18)

Once assembled, the pre-cooked egg product can be stored under refrigeration conditions for an extended period prior to consumption while still maintaining suitable levels of Listeria growth. Suitable refrigeration conditions may range between about 32 ° F. and 45 ° F., more particularly, between about 34° F. and 40° F. As further demonstrated in the examples, embodiments of the present invention are capable of inhibiting Listeria growth to less than 2 average log for at least about two weeks, more particularly for at least about 5 weeks, even more particularly, at least about 10 weeks under refrigerated conditions. Furthermore, certain embodiments containing less than about 25 ppm Nisin (or less than about 0.1 wt % Nisaplin) maintained average log Listeria growth at suitable levels for extended periods under refrigeration. Although the examples focus on Listeria growth, it will be appreciated that other types of bacteria may be inhibited by embodiments of the present invention as well.

The ability to refrigerate the ready-to-eat food product while still maintaining acceptable levels of Listeria growth provides improved flexibility in the distribution, sale and use of products prepared according to embodiments of the present invention. In one embodiment, for example, the product may be frozen during resale and/or distribution, and then placed in a refrigerated display cooler for retail sale. In another embodiment, the product may remain frozen up through sale, but can be subsequently refrigerated until consumption. In yet another embodiment, the product may remain refrigerated from packaging through consumption.

### Examples

### Example Protocol

Liquid egg formulations 1-24 and various control formulations were prepared by combining the ingredients listed in the tables set forth in each example below. The actual weight percent of each component varied slightly depending on the amount of citric acid (pH adjustment) and the specific antimicrobial component used in the formulation.

Cooked egg samples were formed by depositing 1.1 fluid ounce of the various formulations into a warm egg pan. The deposited formulation samples were then cooked with direct steam to a cooked temperature of about 165 ° F. After cooking, each sample was placed in a low oxygen modified atmosphere packaging, frozen for up to a week, thawed and then refrigerated for up to 10 weeks. Prior to refrigeration, each cooked sample was inoculated with Listeria and tested for average log Listeria growth as described below.

An inoculant was prepared from three Listeria monocytogenes (Lm) cultures, which were enriched in Brain Heart Infusion broth (BHI) individually and incubated at 35° C. for 14 to 18 hours to obtain approximately 5×10⁸ colony forming units per milliliter (CFU/ml) concentration. The inoculant was prepared by mixing equal parts of each such culture (1:1:1) into a sterile container. The inoculant was then serially diluted to obtain a level of 5.0×10² to 5.0×10⁶ CFU/ml.

Cooked samples of each egg formulation were surface inoculated via syringe with 1.0 ml of the inoculant. Injection was performed through a sanitized septum that had been placed on sanitized packaging surrounding the patty. The injection was performed slowly, allowing the inoculant to absorb into the egg patty. After inoculation, the septum was re-sanitized and tape was placed over the septum to ensure that it wouldn't leak.

All inoculated samples were incubated at 4.0° C.±1.0° C. (between about 37° F. and 41° F.). Post inoculation testing was performed initially (day 0) and weekly thereafter for 10 weeks. Two samples per patty were tested individually for each testing period except the initial (Day 0), in which one sample was tested. Testing was performed by weighing each sample and adding in 9× each sample's individual weight in buffered peptone water to obtain a 10:1 dilution. Subsequent dilutions were made, depending on results from the previous testing period.

Plating was completed by taking 1.0 ml of each dilution and spreading approximately 0.5 ml across 2 Modified Oxford Medium (MOX) plates. The MOX plates were incubated, upright, for 24 hours at 35° C. to allow the inoculums to be absorbed onto the surface of the plate. Plates were inverted and incubated for an additional 24 hours at 35° C. for a total incubation time of 48 hours. The plates were enumerated, dilution factor applied, and recorded as number of viable cells per gram of product.

### Example 1

Liquid egg formulations 1-3 and a control were prepared by combining the components provided in Tables 1 and 2 below. Samples of each liquid egg formulation were processed, inoculated and tested as described in the Experimental Protocol except that two inoculations were performed on each sample formulation and the control formulation. The “Low” inoculation was designed to achieve 1 average log Listeria at day 0. The “High” inoculation was designed to achieve 5 average log Listeria at day 0. Additionally, weekly tests were substituted with tests performed at days 5, 7, 14, 21, 40 and 56.

TABLE 1

| Sample Ingredients | Sample Wt % |
|---|---|
| Pasteurized Whole Egg | 70.0-76.0 |
| Water | 16.0-18.0 |
| Non-fat Dry Milk | 1.50-2.40 |
| Vegetable Oil | 1.50-2.40 |
| Modified Food Starch | ≈0.48 |
| Salt | ≈0.65 |
| Xanthan Gum | ≈0.10 |
| Artificial/Natural Flavors | ≈0.45 |
| Citric Acid | 0.00-0.08 |
| | (pH adjustment) |
| Trehalose | ≈2.00 |
| Antibacterial Composition | See Table 2 Below |

TABLE 2

| | Antibacterial | |
|---|---|---|
| Formulation | Composition | Wt % |
| #1 | Mirenat N | 0.3 |
| #2 | NovaGard CB-1 | 1.5 |
| #3 | Nisaplin ND | 0.1 |
| | | (≈25 ppm Nisin) |
| Control | None | 0.0 |

Novagard CB-1 ™ is commercially available from Danisco, and includes maltodextrin, cultured dextrose, sodium diacetate, Nisin and egg white lysozyme.
Mirenat N is a lauric acid derivative available from A&B Ingredients.
Nisaplin ND is a Nisin formulation available from Danisco A/V.

FIG. 2 summarizes the results of the experiment. After 56 days, Formulation 3, which included Nisaplin ND at 0.1 wt %, maintained the lowest average log Listeria growth over 56 days for both the “Low” and “High” inoculation samples.

### Example 2

Liquid egg formulations 4-8 are set forth in Tables 3 and 4 below, and were prepared and tested for the presence of Listeria as described in the Experimental Protocol. Inoculation was designed to achieve 1 average log Listeria at day 0. No control was included in this example, but a control would likely have performed similar to controls included in the other examples.

TABLE 3

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.20 |
| Xanthan Gum | ≈0.15 |
| Artificial/Natural Flavors | ≈0.07 |
| Citric Acid | 0.00-0.08 |
| | (pH adjustment) |
| Trehalose | ≈2.00 |
| Antibacterial Composition | See Table 4 Below |

TABLE 4

| Antibacterial | Form. 4 | Form. 5 | Form. 6 | Form. 7 | Form. 8 |
|---|---|---|---|---|---|
| Component | (wt %) | (wt %) | (wt %) | (wt %) | (wt %) |
| Nisaplin ND | 0.1 | 0.1 | 0.1 | 0.1 | 0.1 |
| | (25 ppm | | | | |
| | Nisin) | | | | |
| NovaGARD | 0 | 0.3 | 0 | 0 | 0 |
| Lysozyme | | | | | |
| PURASAL | 0 | 0 | 3.0 | 0 | 0 |
| Opti. Form PD | | | | | |
| Plus | | | | | |
| PURASAL | 0 | 0 | 0 | 3.0 | 0 |
| HiPure Plus | | | | | |
| Novagard CB-1 | 0 | 0 | | | 0.5 |

NovaGARD Lysozyme is commercially available from Danisco and includes 20,000 active units per milligram of egg white lysozyme.
PURASAL HiPure Plus ™ is commercially available from Purac and includes 78% potassium lactate.
PURASAL Opti. Form PD Plus ™ is also commercially available from Purac and includes 72.8% potassium lactate and 5.2% sodium diacetate.

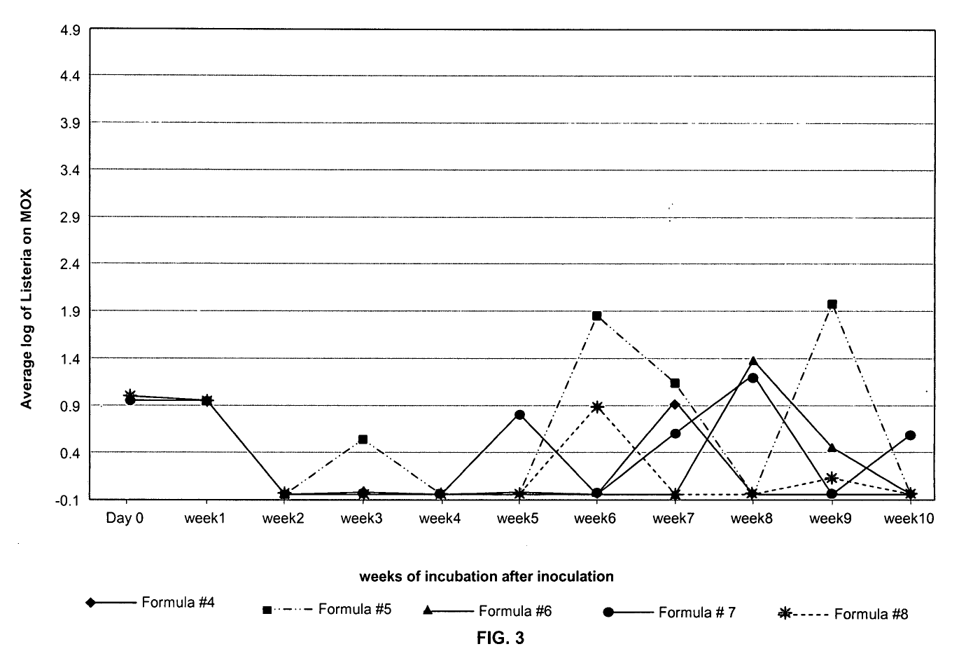

FIG. 3 summarizes the results of the experiment. Each of formulations 4-8 exhibited less than 2 average log Listeria growth for the duration of the 10 week experiment. Examples 1 and 2 indicate that the use of at least about 0.1 wt % Nisaplin ND (at least about 25 ppm Nisin) maintains Listeria growth in the pre-cooked egg product at suitable levels for extended refrigerated storage.

### Example 3

Liquid egg formulations 9-11 set forth in Tables 5 and 6 below were prepared and tested for the presence of Listeria as described in the Experimental Protocol. Inoculation was designed to achieve 2.5 average log Listeria at day 0. Each formulation includes less than 0.1 wt % Nisaplin ND (less than about 25 ppm Nisin).

TABLE 5

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.47 |
| Salt | ≈0.22 |
| Xanthan Gum | ≈0.15 |
| Artificial/Natural Flavors | ≈0.07 |
| Citric Acid | 0.00-0.08 |
| | (pH adjustment) |
| Trehalose | ≈1.00 |
| Antibacterial Composition | See Table 6 Below |

TABLE 6

| Antibacterial | Form. 9 | Form. 10 | Form. 11 | |
|---|---|---|---|---|
| Component | (wt %) | (wt %) | (wt %) | Control |
| Nisaplin ND | 0.05 | 0 | 0.05 | 0 |
| | (12.5 ppm | | | |
| | Nisin) | | | |
| Potassium Sorbate | 0 | 0.3 | 0.3 | 0 |
| Sodium Propionate | 0 | 0.3 | 0.3 | 0 |

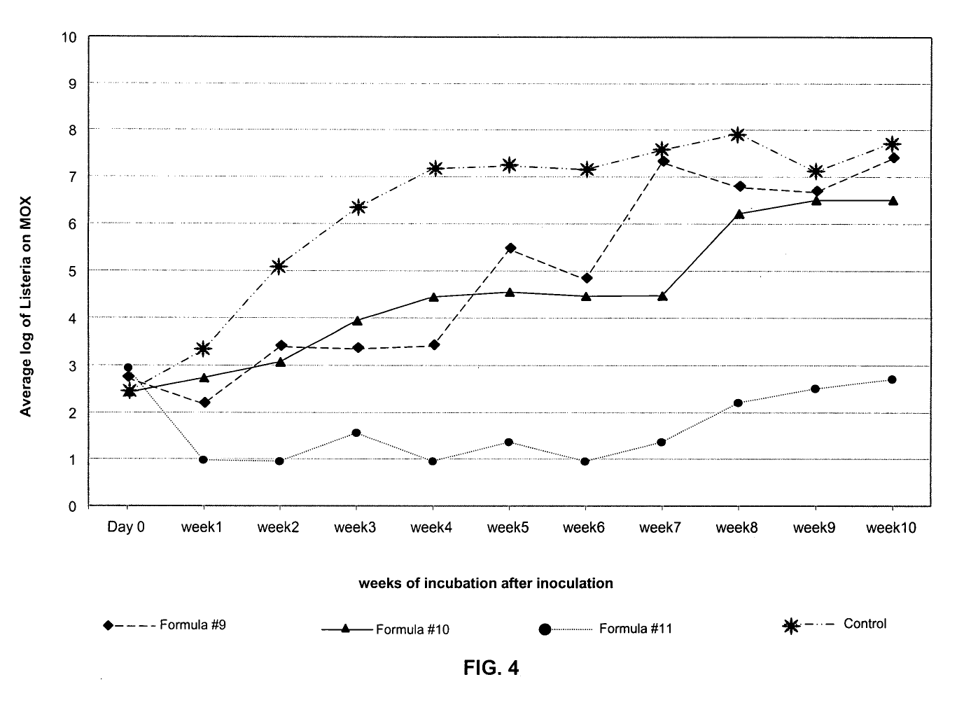

FIG. 4 summarizes the results of the experiment. Formulation 11, which included potassium sorbate, sodium propionate and Nisin at a reduced concentration (12.5 ppm), exhibited less than 2 average log Listeria growth over the 10 week period.

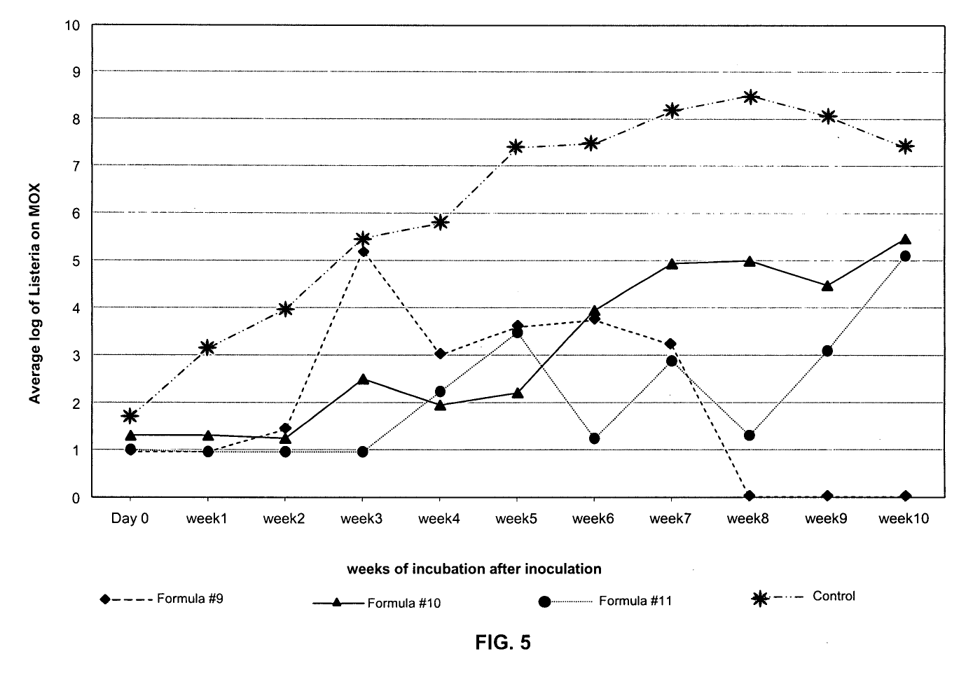

Example 3 was then repeated except that cooked egg samples of each formulation were frozen for 5 weeks (instead of up to one week) before inoculation. FIG. 5 summarizes the results of the experiment.

### Example 4

Liquid egg formulations 12-15 set forth in Tables 7 and 8 below were prepared and tested for the presence of Listeria as described in the

Experimental Protocol. Inoculation was designed to achieve 1 average log Listeria at day 0. For Example 4, various concentrations and combinations of the organic salts utilized in Formulation 11 were tested. Control #2 was added because Formulation 15 was tested separately from the other formulations.

TABLE 7

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.2 |
| Xanthan Gum | ≈0.15 |
| Artificial/Natural Flavors | ≈0.08 |
| Citric Acid | 0.00-0.08 |
| | (pH adjustment) |
| Antibacterial Composition | See Table 8 Below |

TABLE 8

| | | | Form. | Form. | |
|---|---|---|---|---|---|
| Antibacterial | Form. 12 | Form. | 14 | 15 | Controls |
| Component | (wt %) | 13 (wt %) | (wt %) | (wt %) | 1 & 2 |
| Nisaplin ND | 0.05 | 0.05 | 0.05 | 0.05 | 0 |
| | (12.5 ppm | | | | |
| | Nisin) | | | | |
| Potassium | 0.3 | 0.15 | 0.23 | 0.30 | 0 |
| Sorbate | | | | | |
| Sodium | 0.15 | 0.15 | 0.23 | 0 | 0 |
| Propionate | | | | | |

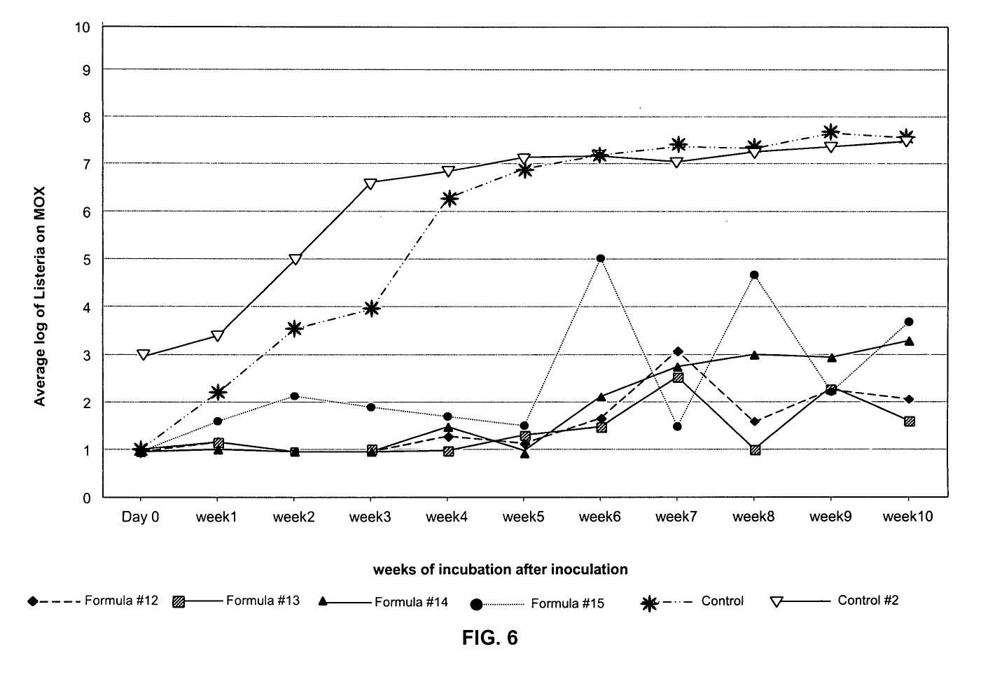

FIG. 6 summarizes the results of the experiment. Each Formulation maintained average Log Listeria growth at suitable levels for extended periods.

### Example 5

Liquid egg formulations 16-18 set forth in Tables 9 and 10 below were prepared and tested for the presence of Listeria as described in the Experimental Protocol. Inoculation was designed to achieve between 1 and 2 average log Listeria at day 0. In Example 5, additional formulations utilizing organic acids or salts were tested.

TABLE 9

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.2 |
| Xanthan Gum | ≈0.15 |
| Artificial/Natural Flavors | ≈0.08 |
| Citric Acid | 0.00-0.08 |
| | (pH adjustment) |
| Antibacterial Composition | See Table 10 Below |

TABLE 10

| Antibacterial | Form. 16 | Form. 17 | Form. 18 | |
|---|---|---|---|---|
| Component | (wt %) | (wt %) | (wt %) | Control |
| Nisaplin ND | 0.05 | 0.05 | 0.05 | 0 |
| | (12.5 ppm Nisin) | | | |
| Potassium Sorbate | 0.3 | 0 | 0 | 0 |
| Propionic Acid | 0 | 0.30 | 0.15 | 0 |

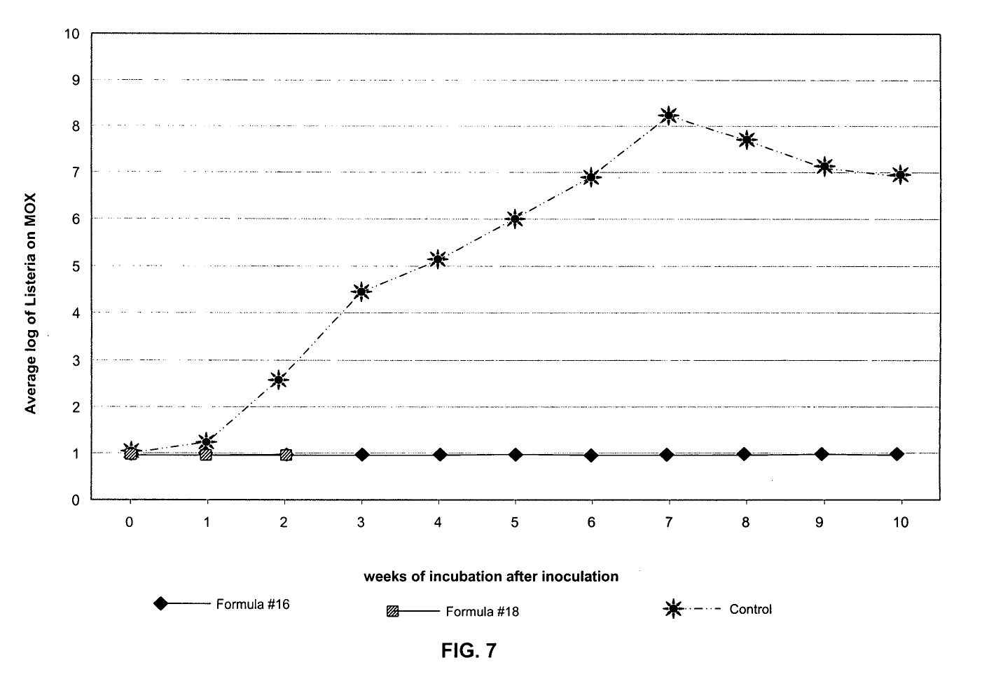

FIG. 7 summarizes the results of the experiment. Listeria growth for Formulation 17 was not tested because the egg product did not cook properly. Testing for Formulation 18 was discontinued after Listeria growth exceeded a desirable level. Average log Listeria growth for Formulation 16, which included 12.5 ppm Nisin and 0.3 wt % potassium sorbate, remained below 2 through the 10 week testing period.

### Example 6

Liquid egg formulations 19-22 set forth in Tables 11 and 12 below were prepared and tested for the presence of Listeria as described in the Experimental Protocol. Inoculation was designed to achieve 4 average log Listeria at day 0. In Example 6, additional formulations utilizing sodium benzoate were tested.

TABLE 11

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.2 |
| Xanthan Gum | ≈0.15 |
| Artificial/Natural Flavors | ≈0.08 |
| Citric Acid | 0.00-0.08 |
| | (pH adjustment) |
| Antibacterial Composition | See Table 12 Below |

TABLE 12

| Antibacterial | Form. 19 | Form. | Form. | Form. 22 | |
|---|---|---|---|---|---|
| Component | (wt %) | 20 (wt %) | 21 (wt %) | (wt %) | Control |
| Nisaplin ND | 0.05 | 0.05 | 0 | 0 | 0 |
| | (12.5 ppm | | | | |
| | Nisin) | | | | |
| Potassium | 0.3 | 0 | 0.3 | 0.0 | 0 |
| Sorbate | | | | | |
| Sodium | 0.1 | 0.1 | 0.1 | 0.1 | 0 |
| Benzoate | | | | | |
| Sodium | 0 | 0 | 0 | 0.3 | 0 |
| Propionate | | | | | |

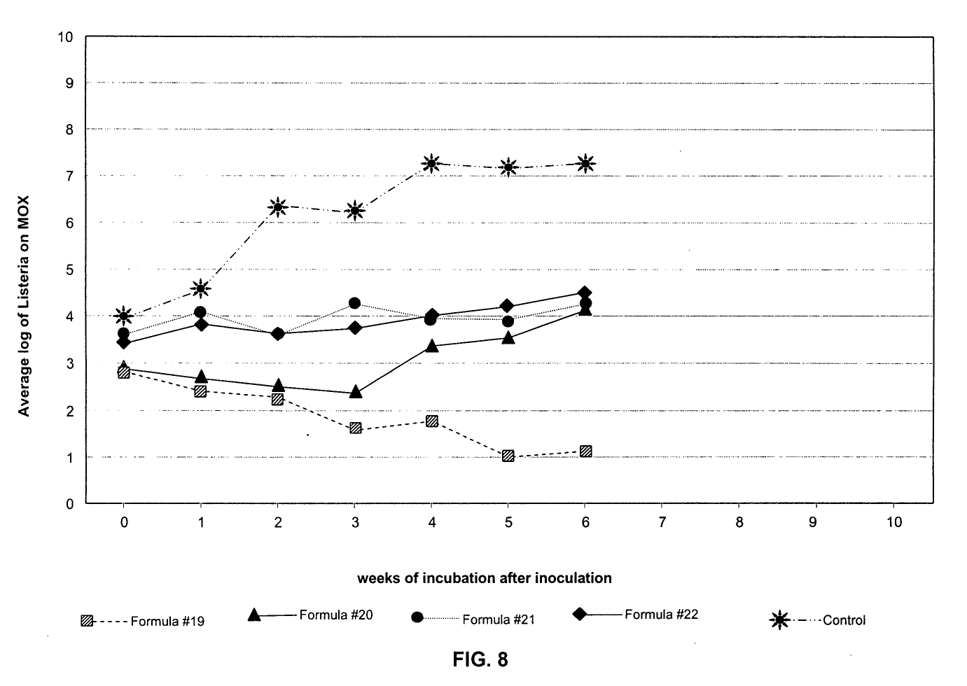

FIG. 8 summarizes the results of the experiment. Over a six week period, each formulation maintained less than 2 Log average Listeria growth based on the level of Listeria present at day zero.

### Example 7

Liquid whole egg formulations 23-24 set forth in Tables 13 and 14 below and liquid egg white formulation 25 set forth in Tables 15 and 16 below were prepared and tested for the presence of Listeria as described in the Experimental Protocol. Inoculation was designed to achieve 3 average Log Listeria at Day 0. In Example 7, additional formulations utilizing potassium sorbate and/or sodium propionate were tested.

TABLE 13

| Formulation Ingredient | Approximate Wt % |
|---|---|
| Pasteurized Whole Egg | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.2 |
| Xanthan Gum | ≈0.15 |
| Artificial/Natural Flavors | ≈0.08 |
| Citric Acid | 0.00-0.08 |
| | (pH adjustment) |
| Antibacterial Composition | See Table 14 Below |

TABLE 14

| Antibacterial | Form. 23 | Form. 24 | Control - |
|---|---|---|---|
| Component | (wt %) | (wt %) | Whole Egg |
| Nisaplin ND | 0.05 | 0.05 | 0 |
| | (12.5 ppm Nisin) | | |
| Potassium Sorbate | 0.3 | 0.3 | 0 |
| Sodium Propionate | 0 | 0.3 | 0 |

TABLE 15

| Formulation Ingredient | Approximate Wt % |
|---|---|
| Pasteurized Egg White | 63.5-70.0 |
| Water | 22.0-24.0 |
| Non-fat Dry Milk | 2.50-2.75 |
| Vegetable Oil | 4.70-5.10 |
| Modified Food Starch | ≈1.49 |
| Salt | ≈0.2 |
| Xanthan Gum | ≈0.15 |
| Artificial/Natural Flavors | ≈0.08 |
| Citric Acid | 0.00-0.08 |
| | (pH adjustment) |
| Antibacterial Composition | See Table 16 Below |

TABLE 16

| Antibacterial | Form. 25 | Control - |
|---|---|---|
| Component | (wt %) | Whites |
| Nisaplin ND | 0.05 | 0 |
| | (12.5 ppm Nisin) | |
| Potassium Sorbate | 0.3 | 0 |
| Sodium Propionate | 0 | 0 |

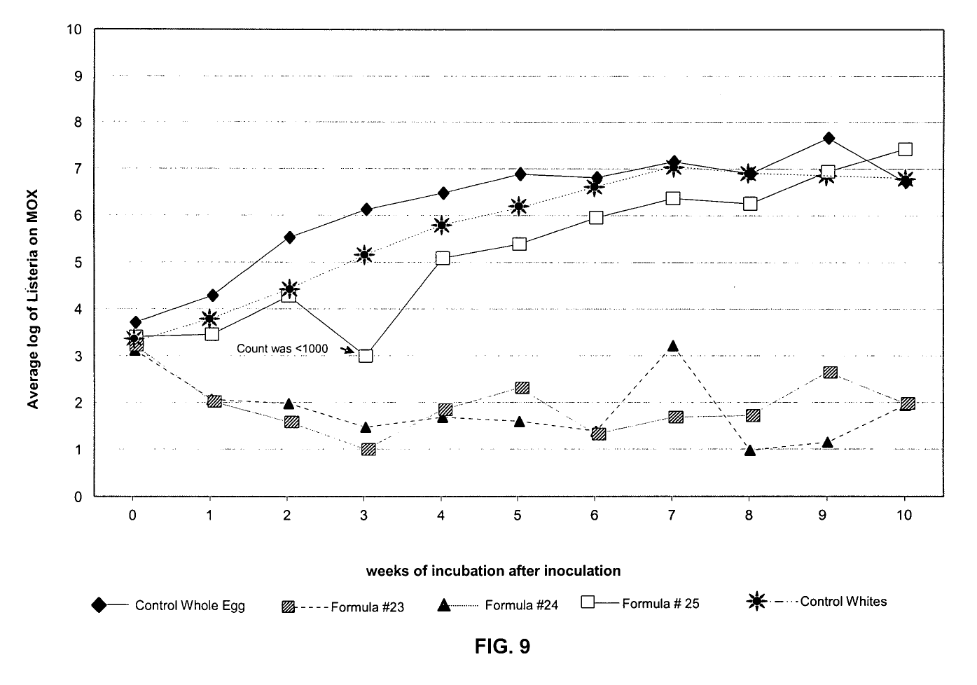

FIG. 9 summarizes the results of the experiment. Over a ten week period, both whole egg formulations maintained less than 2 Log average Listeria growth, whereas formulation 25 containing only liquid egg whites had greater than 2 Log average Listeria growth.

1. A method for preparing a food product containing a pre-cooked egg material, the method comprising:
combining a liquid whole egg material with an antibacterial composition;
heating the liquid whole egg material to form the pre-cooked egg material;
packaging the pre-cooked egg material; and
storing the packaged pre-cooked egg material under refrigerated conditions for a period of time prior to consumption, wherein an effective amount of the antibacterial composition is combined with the liquid egg material to inhibit Listeria growth in the pre-cooked egg material during refrigeration.

2. The method of claim 1 wherein the antibacterial composition includes Nisin.

3. The method of claim 2 wherein the liquid whole egg material includes about 25 ppm or greater Nisin 20

4. The method of claim 2 wherein the liquid whole egg material includes less than about 25 ppm Nisin.

5. The method of claim 2 wherein the liquid whole egg material includes between about between about 5 ppm and about 20 ppm Nisin.

6. The method of claim 1 wherein the antibacterial composition includes at least one organic acid or salt thereof.

7. The method of claim 1 wherein the antibacterial composition includes Nisin and at least one organic acid or salt.

8. The method of claim 7 wherein the liquid whole egg material includes Nisin at a concentration of less than about 25 ppm and at least about 0.1 wt % organic acid or salt.

9. The method of claim 8 wherein the liquid whole egg material includes between about 0.1 wt % and 0.6 wt % organic acid or salt.

10. The method of claim 8 wherein the liquid whole egg material includes between about 0.3 wt % and 0.6 wt % organic acid or salt. 10

11. The method of claim 7 wherein the organic acid or salt includes a sorbate salt.

12. The method of claim 11 wherein the sorbate salt includes potassium sorbate.

13. The method of claim 12 wherein the anti-bacterial composition includes a sorbate salt and at least one of a propionate salt and a benzoate salt.

14. The method of claim 1 wherein the packaging step includes packaging the pre-cooked egg material in low oxygen modified atmosphere packaging.

15. The method of claim 1 wherein an effective amount of the antibacterial composition is combined with the liquid whole egg material to limit the average growth of Listeria to less than 2 log during refrigeration for at least about 5 weeks.

16. The method of claim 1 wherein an effective amount of the antibacterial composition is combined with the liquid whole egg material to limit the average growth of Listeria to less than 2 log during refrigeration for at least about 10 weeks.

17. A packaged pre-cooked whole egg product comprising an antibacterial composition including less than about 25 ppm Nisin and a sorbate salt.

18. The packaged pre-cooked egg product of claim 17 including at least about 0.1 wt % sorbate salt.

19. The packaged pre-cooked egg product of claim 18 including at least about 0.3 wt % sorbate salt.

20. The packaged pre-cooked egg product of claim 17 wherein the sorbate salt includes potassium sorbate.

21. The packaged pre-cooked egg product of claim 17 further comprising at least one of a propionate salt or a benzoate salt.

22. A pre-cooked whole egg product comprising less than about 25 ppm Nisin and an effective amount of at least one organic acid or organic acid salt thereof to inhibit Listeria growth to less than 2 log average growth during refrigeration for at least about 10 weeks.
